(19) United States
(12) Patent Application Publication
(10) Pub. No.: US 2025/0198742 A1
(43) Pub. Date: Jun. 19, 2025

(54) Line-field OCT System with K Space Calibration

(71) Applicant: KineoLabs, Inc., Billerica, MA (US)

(72) Inventor: Walid A. Atia, Jamaica Plain, MA (US)

(21) Appl. No.: 18/981,070

(22) Filed: Dec. 13, 2024

Related U.S. Application Data
(60) Provisional application No. 63/609,916, filed on Dec. 14, 2023.

(51) Int. Cl. G01B 9/02091; G01B 9/02; G01B 9/02055

(52) U.S. Cl. CPC G01B 9/02091; G01B 9/02037; G01B 9/02044; G01B 9/02062; G01B 9/02089

(57) ABSTRACT

A line-field optical coherence tomography (OCT) system and method provide enhanced imaging accuracy through k-linearization of interference data. The system includes a swept laser source, a line-field sensor, and a single board computer (SBC) with processing capabilities. The system uses a frequency reference to produce a periodic reference pattern, which is detected by a subset of pixels in the line-field sensor. The SBC determines a resampling curve based on the reference pattern to correct non-linearities in the wavelength tuning of the laser. The resampling curve is applied to k-linearize the interference data, enabling the generation of high resolution transform-limited depth profiles through inverse Fourier transform. Methods are disclosed for recalculating the resampling curve periodically, continuously, or adaptively based on a linearity threshold. The system can further update the laser's tuning function dynamically to ensure consistent performance. These advancements enable precise and efficient OCT imaging for applications such as ophthalmology, angiography, and other diagnostic uses.

### RELATED APPLICATIONS

This application claims the benefit under 35 USC 119 (e) of U.S. Provisional Application No. 63/609,916, filed on Dec. 14, 2023, which is incorporated herein by reference in its entirety.

### BACKGROUND OF THE INVENTION

Optical coherence tomography (OCT) is a cross-sectional, non-invasive imaging modality that is used in many areas of medical imaging. For example, in ophthalmology, OCT has been widely used for imaging the retina, choroid and anterior segment. Functional imaging of the blood velocity and vessel microvasculature is also possible.

Fourier-domain OCT (FD-OCT) has recently attracted more attention because of its high sensitivity and imaging speed compared to time-domain OCT (TD-OCT), which uses an optical delay line for mechanical depth scanning with a relatively slow imaging speed. The spectral information discrimination in FD-OCT is accomplished either by using a dispersive spectrometer in the detection arm (spectral domain or SD-OCT) or rapidly scanning swept laser source (swept-source OCT or SS-OCT).

Compared to spectrometer-based FD-OCT, SS-OCT has several advantages, including its robustness to motion artifacts and fringe washout, lower sensitivity roll-off and higher detection efficiency.

Commercial ophthalmic swept source OCT systems are traditionally flying spot systems. The systems scan the eye, resolving an A-scan at every point. A volume is built up typically by raster scanning the spot across the eye, typically the retina. The raster scanning is conventionally accomplished with an orthogonal pair of galvanometers. This translates to very challenging requirements for the swept sources, which must sweep through their scanband for each point before moving to the next point.

Many different approaches have been implemented to develop high-speed swept sources for SS-OCT. One approach employs a semiconductor optical amplifier (SOA) based ring laser design (see for example Yun et al “High-speed optical frequency-domain imaging” Opt. Express 11:2953 2003, and Huber et al “Buffered Fourier domain mode locking: unidirectional swept laser sources for optical coherence tomography imaging at 370,000 lines/s,” Opt. Express 13, 3513 2005). Short cavity lasers (see for example Kuznetsov et al “Compact Ultrafast Reflective Fabry-Perot Tunable Lasers For OCT Imaging Applications,” Proc. SPIE 7554: 75541F 2010) are another example. SOA based ring laser designs have been practically limited to positive wavelength sweeps (increasing wavelength) because of the significant power loss that occurs in negative tuning. This has been attributed to four-wave mixing (FWM) in SOAs causing a negative frequency shift in intracavity light as it propagates through the SOA (Bilenca et al “Numerical study of wavelength-swept semiconductor ring lasers: the role of refractive-index nonlinearities in semiconductor optical amplifiers and implications for biomedical imaging applications,” Opt. Lett. 31:760-762 2006).

At the same time, other architectures exist for SS-OCT that reduce the performance requirements for the swept laser source. Fechtig et al in an article entitled Line-Field parallel swept source MHz OCT for structural and functional retinal imaging, Biomedical Optics Express 716, vol. 6, no. 3, (2015) describes a system that achieves 1 MHz equivalent A-scan rates by combining a lower sweep rate laser with a linear, line-field sensor. Even earlier examples exist such as Line-Field Optical Coherence Tomography Using Frequency-Sweeping Source by Lee et al in IEEE Journal of Selected Topics in Quantum Electronics, Vol. 14, No. 1, January 2008.

The interference data collected by SS-OCT systems needs to be evenly distributed in wavenumber space (k-space) because the Fourier transform, which is used to reconstruct depth profiles (A-scans), assumes that the sampled data is uniformly spaced in k-space. This assumption is critical for achieving the highest transform-limited resolution along the axial (depth) direction.

If the spectral data is not evenly distributed in wavenumber space k-space, the non-linear sampling introduces distortions in the Fourier transform, leading to artifacts, reduced axial resolution, and inaccurate depth measurements in the resulting image. This is because the Fourier transform inherently depends on the uniformity of the sampling interval to resolve spatial frequencies correctly. Non-uniform sampling can cause aliasing or misrepresentation of depth structures, degrading image quality.

K-linearization corrects this by resampling the spectral data to align with evenly spaced points in k-space, ensuring that the Fourier transform operates as intended. This step is particularly important for applications requiring high-resolution imaging, such as ophthalmic diagnostics or microvascular imaging, where precise axial detail is crucial.

Most swept sources for SS-OCT systems are controlled to tune through the scanband linearly. Yet, most do not tune linearly enough to achieve the highest possible performance. K-linearization refers to the process of resampling the acquired spectral interference data so that it is evenly distributed in k-space.

To achieve k-linearization, a frequency reference (such as an etalon) is used to monitor the instantaneous wavenumber during the laser sweep. The detected spectral fringes from the reference are analyzed to determine deviations from ideal linear tuning. A resampling curve is then calculated to redistribute the spectral data points evenly in k-space. This ensures that the interference data corresponds to uniformly spaced wavenumbers, thereby improving the quality of depth profiles and tomographic images. K-linearization is critical in applications requiring high axial resolution and is typically implemented as a preprocessing step before Fourier transformation.

### SUMMARY OF THE INVENTION

To a first order, K-linearization can also be achieved by carefully controlling the tuning characteristic of the swept source. For common wavelengths of operation, the swept sources must be swept across relatively wide scanbands. For systems operating in the 800-900 nanometer (nm) band, the swept source should sweep across a scanband of greater than 50 nm. Systems operating at longer wavelengths will have scanbands closer to 100 nm wide. Such relatively wide band laser tuning requires some type of intracavity mechanical tuning system to tune the laser. Micromechanical system (MEMS) membranes and Fabry-Perot tunable filters are used in some examples. Other approaches include tilting bandpass interference filters and tilting gratings. In all these cases, there is a transfer function between the intracavity mechanical tuning system and the instantaneous wavelength of the laser. K-linearization requires that the transfer function be understood so that the laser's sweep through the scanband is linear in frequency, or at least as linear as possible given the mechanical constraints.

Both resampling and tuning k-linearization require a frequency reference across the sweep period to precisely monitor the instantaneous frequency of the laser. In conventional systems, this frequency reference is often acquired with a separate fiber interferometer or etalon that receives part of the laser's emission and the transmission of the interferometer or etalon or similar spectral reference is monitored with a separate detector and analog to digital converter.

The present invention utilizes one or several pixels of a line-field sensor to track sweep linearity and therefore enable k-linearization.

In general, according to one aspect, the invention features an optical coherence tomography (OCT) system that includes a swept laser source that emits light with a wavelength tuned across a predefined scanband. A line-field sensor, arranged to receive interference signals corresponding to light scattered from a sample and reference light, simultaneously detects a periodic reference pattern generated by a frequency reference interacting with a portion of the swept laser source's output. By dedicating a subset of the sensor's linear array of pixels, for example those at one end of the array, to capture these reference signals, the system obtains a known periodic pattern that reflects the laser's instantaneous wavenumber. Using this reference pattern, a computer or processor determines a resampling curve to compensate for any non-linearities in the wavelength tuning of the swept laser source. The resampling curve can be applied to the interference signals to achieve k-linearization, and subsequently, an inverse Fourier transform is performed on the k-linearized data to yield depth profiles. These profiles are combined to form tomographic images displayed to the user. In some embodiments, the system includes a scanning mechanism to translate the line of illumination over the sample, generating a series of k-linearized depth profiles at different lateral positions for full volumetric imaging.

In other aspects, the swept laser source is equipped with an intracavity mechanical tuning mechanism and a tuning curve module that stores a predefined tuning function governing the wavelength sweep. A controller evaluates the linearity of the tuning based on the detected reference signals and determines a resampling curve to correct for any observed non-linearities. Additionally, this controller can update the predefined tuning function in the tuning curve module to achieve more consistent wavelength sweeps in future scans. The result is an OCT system that can adaptively recalibrate both software-based k-linearization and the hardware-based tuning function over time.

Further embodiments involve the use of an etalon or other frequency reference element that covers only a portion of the line-field sensor's pixel array. By restricting the reference pattern detection to a known set of “reference pixels,” the system can simultaneously acquire both interferometric sample data and the periodic pattern used for k-calibration. The reference pixels provide the necessary instantaneous wavenumber information, ensuring that the system can compensate for frequency non-linearities in real-time or periodically, as needed, to maintain stable and accurate axial resolution.

A related method for OCT imaging involves capturing interference signals and reference signals during the tuning of the swept laser source, determining a resampling curve from the reference pattern to address tuning non-linearities, and applying this curve to k-linearize the interferometric data. After k-linearization, an inverse Fourier transform reveals depth profiles suitable for tomographic imaging. Optionally, the method includes updating a predefined tuning function for the swept source based on the determined resampling curve, thereby improving the linearity of future wavelength sweeps.

In another method directed toward calibration of the swept laser source, reference signals generated by the frequency reference are captured and analyzed to assess wavelength sweep linearity. From these measurements, a resampling curve and/or updates to the stored tuning function are derived, enabling the system to ensure that acquired interference signals are k-linearized. This calibration method thus sets the stage for generating high-quality tomographic images with improved axial resolution and reduced artifacts.

These embodiments and methods enhance OCT system performance by integrating a frequency reference directly in front of a subset of the line-field sensor's pixels, enabling simultaneous acquisition of sample and reference data. The resultant dynamic adjustment of both the resampling curve and the predefined tuning function leads to more accurate, robust, and stable OCT imaging.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is schematic diagram of a cat's-eye tunable laser in a line-field parallel swept source OCT system;

FIG. 2 is a plot of the laser frequency, tuning curve and angle of the angle control actuator 132, and etalon's periodic transmission providing a frequency or wavenumber reference during the collection of a thousand line-interference signals for a B-scan;

FIG. 3 is a schematic top view showing the line-field sensor's pixel array with the periodic frequency reference; and

FIGS. 4A, 4B, 4C and 4D are flow charts showing different approaches for calculating a new resampling curve and/or tuning curve for k-linearization.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

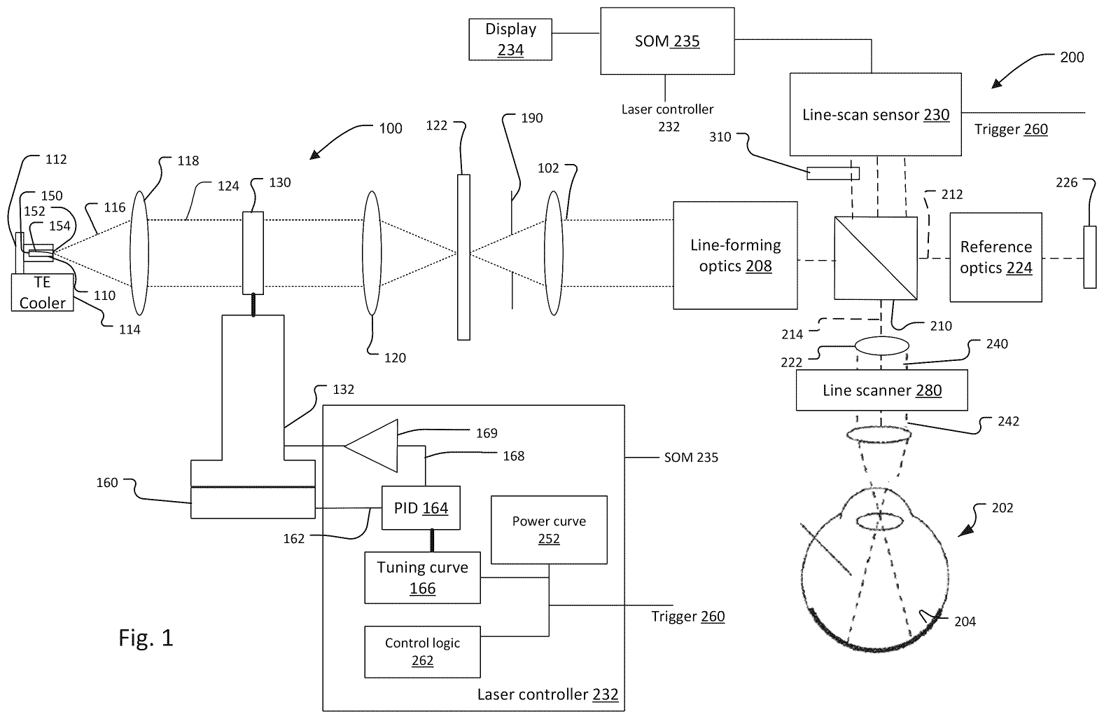

FIG. 1 shows a line-field or line parallel swept source OCT system 200. In the preferred embodiment, a cat's-eye tunable laser 100 is used as the swept source, although the present invention can be applied to other tunable laser technologies such as MEMS, grating, acousto-optic tunable filter tuned lasers, to list a few examples.

The invention is also applicable to swept source OCT systems 200 that do not rely on controlling the swept source to tune linearly in frequency but instead resample to achieve k-linearization or those that employ a combination of these two approaches.

The laser's amplification is provided by a GaAlAs gain chip 110, in one example. The gain chip 110 amplifies light in the wavelength range of about 800 to 900 nanometers. Preferably its center wavelength is around 840 nanometers, which is useful for applications such as ophthalmic imaging and other diagnostic uses because of the water window (650 to 950 nm) at these wavelengths. Another advantage of this wavelength range is that it can be detected with standard cameras with silicon-based imager chips or sensors. Specifically, the output is detected with silicon, e.g., complementary metal-oxide-semiconductor (CMOS) or charge-coupled device (CCD), imagers.

In other examples, the laser operates in different wavelength ranges. Other examples operate around approximately 1050 nm or 1310 nm, which are the locations of other water windows. The problem with these ranges, however, is that they require InGaAs line-field sensors that are more expensive than the commodity silicon devices that work at shorter wavelengths.

In the current embodiment, the gain chip 110 is mounted in a TO-can type hermetic package 112. This protects the chip 110 from dust and the ambient environment including moisture. In some examples, the TO-can package has an integrated or a separate thermoelectric cooler 114.

The chip 110 is preferably a single angled facet (SAF) edge-emitting chip. As such, it has a high reflectivity (HR) coated rear facet 150. It has an antireflective (AR) coated front facet 152. In addition, for improved performance, it has a curved ridge waveguide 154 that is perpendicular to the rear facet 150 but is angled at the interface with the front facet 152. This angling at the front facet along with the AR coating reduces reflections at the front facet reflectivity by up to 40 dB and significantly improves laser performance by reducing parasitic reflections that can otherwise lead to non-smooth tuning and mode-hopping.

The free space beam 116 from the package 112 is diverging in both axes (x, y). It is collimated by a collimating lens 118. The resulting collimated beam 124 is received by a cat's eye focusing lens 120, which focuses the light onto a cat's eye mirror/output coupler 122. This defines the other end of the laser cavity, extending between the mirror/output coupler 122 and the back/reflective facet of the gain chip 110.

The collimated light 124 between the collimating lens 118 and the cat's eye focusing lens 120 passes through a thin film interference bandpass filter 130. This provides a pass band of approximately 0.3 nanometers (nm) full width at half maximum (FWHM) for OCT applications in one specific example. More generally, its pass band is often between 0.2 nm and 0.5 nm FWHM, or more generally between 0.1 nm and 2 nm FWHM. Even more generally, it is between 0.05 nm to 5 nm FWHM.

The bandpass filter is held on an arm of an angle control actuator 132 that changes the angle of the bandpass filter 130 to the collimated light 124. In one example, the angle control actuator is a galvanometer. In other examples, the angle control actuator 132 is a servomotor or an electrical motor that continuously spins the bandpass filter 130 in the collimated beam 124. This allows for tilting of the bandpass filter 130 with respect to the collimated beam 124 to thereby tilt-tune the filter and thus change the passband to scan or sweep the wavelength of the swept laser 100.

Tuning speed specifications for a galvanometer generally range from 0.1 Hz to 50 KHz. For the higher speeds, a resonant galvanometer can be used along possibly with bi-directional tuning, but higher and lower speeds can be used. Wavelength tuning speed is usually given in nm/sec, so for a 100 Hz tuning speed ideal for retinal imaging applications where a line-speed camera capturing frames at a 100 kHz rate will give 1000 sampled bandwidth points and 70 nm tuning range, this would give 70 nm/10 msec=7000 nm/sec. In general, the tuning speed should be between 3,000 nm/sec and 11,000 nm/sec or higher.

For retinal or industrial imaging with low-cost CMOS or CCD cameras, 840 nm center wavelength is an ideal water window. The tuning range is usually minimally 30 nm of tuning range. Preferably, the tuning range is closer to 60 nm or 70 nm or more. This provides good resolution of <8 micrometers in air. In general, the tuning range should be between 30 nm and 100 nm.

The size of the collimated beam 124 is important for many applications. As a general rule, a smaller beam results in higher divergence resulting in a larger cone half angle (CHA). This reduces the minimum line width over angle for a tunable filter. In the current embodiment, the collimated beam is preferably not less than, i.e., greater than, 1 millimeter (mm) FWHM and is preferably greater than 2 mm FWHM for retinal OCT application. In general, the CHA should be less than 0.04×0.02 degrees and preferably about 0.02×0.01 degrees or less.

The light from the gain chip is polarized. In the common architectures, the polarization is horizontal or parallel to the epitaxial layers of the edge-emitting gain chip 110. In the preferred configuration, the filter is oriented to receive the S polarization in order to maintain narrow line width of the filter as it is tilt tuned. On the other hand, the P polarization broadens drastically at large tilt angles. S polarization has higher loss at larger tilt angles than P. So, the filter design needs to address these issues by providing a low enough loss across the tuning band for S, in the current embodiment.

On the other hand, in some embodiments, the P polarization configurations might be desirable due to the higher powers across the scanband.

In general, the present cat's-eye configuration provides a number of advantages. It provides low loss, low tolerance, repeatable stable operation since it provides for a lower angle wavelength change over grating-based lasers, and can be made at lower cost than AOTF and MEMS lasers.

The mirror/output coupler 122 will typically reflect about 80% of the light back into the laser's cavity and transmit about 20% of light. More generally, the mirror/output coupler can reflect from 10% to 99% of light (transmitting 90% to 1%, respectively), depending on the output power and laser cavity loss desired. Higher reflectivity results in lower loss cavities and thus wider laser tuning range where gain exceeds loss, but results in lower output power. In typical operation, the mirror/output coupler 122 reflects less than 90%.

In some embodiments, an iris or mask 190 is added typically after the mirror output coupler 122 to clip the beam edge. This reduces power fluctuations as the beam wanders due to refraction in the tilting bandpass filter 130. Preferably, it is between 80% and 95% and preferably about 90% of the beam size.

Typically, the diverging beam from the mirror output coupler 122 is collimated with an output collimating lens 140 to form a free space output beam 102.

The angle control actuator 132 is operated as a servomechanism. In the illustrated embodiment, the angle control actuator 132 is a servo controlled galvanometer with an encoder 160. The encoder 160 produces an angle signal 162 indicating the angle of the galvanometer and thus the filter 130 to the collimated beam 124. Preferably, the encoder is an optical encoder and is often analog.

A laser controller 232 receives the angle signal 162 at a PID (proportional-integral-derivative) controller 164. The PID controller 164 compares the angle signal 164 to a specified tuning function stored in the tuning curve module 166. Often, the desired tuning curve is stored in a look up table or is generated algorithmically. This tuning curve is defined so that the laser 100 will sweep across its scanband linearly in frequency to thereby provide or contribute to k-linearization. Often this is an approximately sawtooth or triangular waveform. The PID controller 164 produces the control function 168 that is used to drive the windings of the galvanometer 132 via an amplifier 169.

In the illustrated example, the OCT system 200 is employed for analysis of a human eye 202 and specifically the retina 204. That said, the system can also be used for analysis of other samples, both living and non-living.

In the illustrated example, light in the form of free space beam 102 from the laser 100 passes in free space to line-forming optics 208 and then to a beamsplitter 210, such as a cube beamsplitter, of the OCT interferometer.

Typically, the line-forming optics 208 includes one or more cylindrical lenses and possibly several additional lenses in a beam expander configuration. The line forming optics 208 converts the light from the laser 100 into a line or more specifically a rectangular profile with an aspect ratio of at least 10 to 1 and typically greater than 100:1, and often 400:1, or more. That is, when looking along its optical axis, the light from the line-forming optics 208 has a line or more specifically a rectangular two-dimensional profile that is at least 10 times longer in one dimension than the other dimension, measured at the FWHM.

The beamsplitter 210 divides the light between the reference arm 212 and the sample arm 214 in the illustrated Michelson arrangement. The light propagates in free space between one or more lenses that form projection and collection optics 222 in the sample arm and illuminates the sample 202, a typical sample being tissues 204, e.g. retina or cornea, in a human eye.

The line of light is scanned by a line scanner 280. In some examples the scanning is radial. In other examples, the line is scanned as a paint-brush, i.e., scanned in a direction orthogonal to its major axis.

On the other hand, light in the reference arm 212 is conditioned by one or more lenses of reference arm optics 224 and reflected by reference mirror 226.

The collected sample light received back through the projection and collection optics 222 is combined with reference arm light to form light interference in a line-field camera or sensor 230. The line field sensor typically has a linear array of at least 512 pixels, and often at least 1024 or 2048 pixels to detect interference signals for a line. In a current example, the linear array is a few pixels wide such as between 2 and 10 pixels wide. Often the pixels can be binned in this lateral axis for higher sensitivity. Multiple linear arrays vertically arranged can also be binned to give an effectively taller pixel and lead to improved sensitivity.

The output from the sensor 230 is readout by a single board computer 235, which also controls the system 200 and specifically the laser controller 232. In a current example, the single board computer 235 is System on Module (SOM) that includes a graphic processing unit (GPU), central processing unit (CPU), memory, power management, high-speed interfaces. Currently a Jetson Orin series module is used from NVIDIA Corporation. Alternatively, a PC can be used to read the signal from the sensor through USB, Gigabit ethernet (GigE), coaxpress, or via a frame grabber.

The output from the line field sensor 230 is stored in the SOM 230 and then reconstructed for display on display 234. The Fourier transform of the interference light is performed by the GPU within the SOM 230. This reveals the profile of scattering intensities at different path lengths, and therefore scattering as a function of depth (z-direction) in the sample (see for example Leitgeb et al., “Ultrahigh resolution Fourier domain optical coherence tomography,” Optics Express 12(10):2156 2004). The profile of scattering as a function of depth for a point is called an axial scan (A-scan). The combination of the projected line and line-scan sensor 230 produces a cross-sectional image (tomogram or B-scan) of the sample.

In one implementation, the SOM 235 runs OCTproZ, which is open source software for optical coherence tomography (OCT) processing and visualization is available at github.com/spectralcode/OCTproZ. A plug-in system enables the integration of custom OCT systems and software modules.

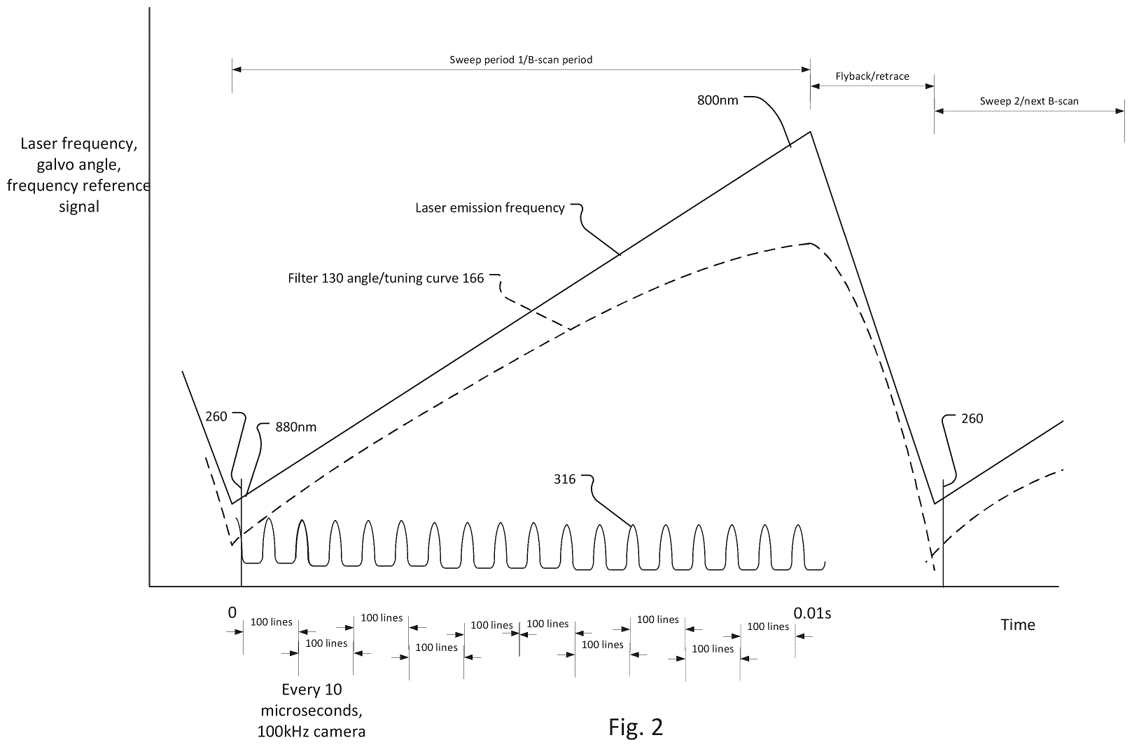

FIG. 2 is a plot of the laser frequency or wavenumber, angle of the angle control actuator 132 for the collection of the line interference signals needed for a B-scan.

In more detail, the control logic 262 triggers the beginning of the scan with the trigger 260. The laser 100 is swept in wavelength so that its frequency changes preferably linearly with time over the sweep or B-scan period. A linear frequency sweep is often desirable because it allows for efficient use of the camera sample rate and can even avoid the need to resample in some embodiments.

For the linear sweep in frequency, the angle of the filter 130 must be tuned in a non-linear fashion. As shown, the rate of change of the angle of the filter 130 slows with increasing angle and shorter wavelengths, and higher frequency of the laser emission 102. This tuning curve for linear frequency sweeping is produced by and/or stored in the tuning curve module 166 and is updated by control of the SOM 235 by downloading a new look up table or tuning curve algorithm into the tuning curve module 166, in one example.

As the laser 100 begins its sweep, the control logic 262 of the laser controller 232 generates the trigger signal 260 that initiates the capturing of the line interference signals as the laser tunes. Preferably, at least 250 line interference signals are captured by the line-scan camera 230 within the sweep period of the laser 100. Currently more than 500 line interference signals, such as 1000 line interference signals or more are captured.

Preferably, the sweep period is less than 0.05 seconds and preferably less than 0.02 seconds. In the current examples, a sweep period of about 0.01 seconds or less provides acceptable B-scans of the human eye despite microsaccades and other movement.

In a current implementation, the line-field camera 230 operates at about 100 k LPS (lines per second) for a sweep period of about 0.01 seconds. Generally, the line-field camera 230 should operation at greater than 20 k LPS to ensure high quality B-scan despite microsaccades, and preferably operates at greater than 100 k LPS. In fact, it can operate at greater than 100 k LPS when performing OCT angiography.

Often several B-scans, typically greater than 10, have been captured and averaged, the control logic 262 controls the scanner 280 to move the project line on the patient's retina. The process repeats and several lines are captured and averaged B-scans are produced for the new location.

The SOM 235 performs the inverse Fourier transform in order to obtain the depth profile from the acquired fringe pattern. There are often several preprocessing steps prior to the IFFT, including background removal, k-linearization, dispersion compensation, and/or windowing. K-linearization should be optimized to maximize image quality. To convert the acquired raw OCT data into a depth profile, the inverse Fourier transform is used, which relates wavenumber k and physical distance. Even with a properly calculated tuning curve 166, the acquired spectral fringe pattern would usually not be perfectly linear in k, even when the tuning curve is periodically recalculated. The k-linearization resamples the raw interference data evenly in k space, which improves axial resolution.

This resampling requires a frequency reference across the sweep period to precisely monitor the instantaneous frequency of the laser for each captured line of the line-field sensor 230. In conventional systems, this frequency reference is often acquired with a separate fiber interferometer or etalon that receives part of the laser's emission and the transmission of the interferometer or etalon is monitored with a separate detector and analog to digital converter. In other cases, especially when the laser shows good scan-scan repeatability, the sample is replaced by an etalon or other spectral periodic reference and the k-linearization is determined, which is then applied to subsequent scans.,

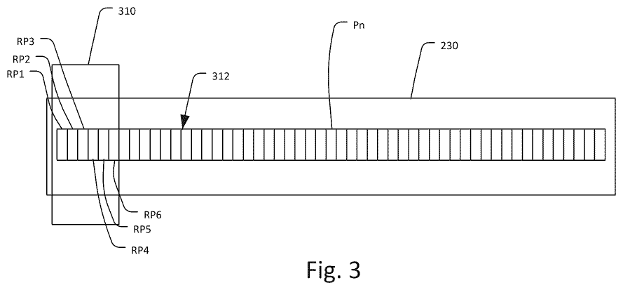

FIG. 3 shows the line-field sensor 230 and its linear array of pixels P. As described previously, the sensor 230 often has hundreds such as at least 512 pixels, and often at least 1024 or 2048 pixels. In the illustrated example, linear array has n pixels in a single pixel wide array, although it could certainly be several pixels wide such as between 2 and 10 pixels wide or more. Often the pixels can be binned in this lateral axis for higher sensitivity.

In the present invention, a frequency reference 310 is placed in front of one or a few pixels P of the line-field sensor 230, termed reference pixels RP. Preferably, the frequency reference produces a predetermined pattern across the scan band of the laser 100. A frequency reference that produces a predetermined and periodic pattern is preferred. Here, an etalon such as a microscope slide or the transmissive substrate is used as a periodic frequency reference 310. It is placed over one or several pixels typically at the beginning or end of the line of pixels P of the line-field sensors. The covered pixels are referred to as reference pixels RP1-RP6 of the linear pixel array 312 of the sensor 230. The remaining portion of the array 312 is used to detect the interference data or fringe patterns from the patient or sample.

Other frequency references could be used such as thin-film interference filters, photonic crystals, and etched diffraction gratings, to list a few examples.

It should be further noted that the frequency reference 310 can be placed elsewhere in the optical train shown in FIG. 1. For example, in another example, the periodic frequency reference 310 is relocated from in front of the line-scan sensor 230 to before the beam splitter 210 or in the reference arm. Still another example is a wedged window, placed close to or made part of the reference mirror 226. Generally, the periodic frequency reference 310 is placed to intercept a portion of a collimated beam in the system 200 after the laser 100 and preferably after the line-forming optics 208. That portion of the beam is then imaged on defined reference pixel or pixels P1-P6 of the linear pixel array 312 of the sensor 230, often at one of the arrays.

With reference back to FIG. 2, these reference pixels detect the frequency reference 310 i.e., etalon's, periodic transmission 316 as the laser 100 is tuned through its sweep of the scanband.

By analyzing the response of the reference pixels RP over the laser's sweep across the scanband, the SOM 235 resolves non-linearities in the sweep of the laser 100 and these non-linearities are used to calculate a resampling curve used to resample the interference data to be linear in k as part of the k-linearization preprocessing step. Furthermore, in some examples, the determined non-linearities in the sweep of the laser 100 are used to further update the tuning function stored in the tuning curve module 166.

The k-linearization process resamples the raw interference data evenly in k space, which improves axial resolution. In one example, the resampling curve r[j] is specified by providing the coefficients of a third order polynomial. The resampling curve is often saved as a look up table in or maintained by the SOM 235. The resampling curve assigns every index j of the raw data array S_{raw}[j] an index j′, i.e. j′=r[j]. To obtain a k-linearized raw data array Sₖ[j], the value at the index j′ needs to be interpolated and remapped to the array position with index j.

The step of performing the k-linearization involves interpolation of the interference data of each sweep of the laser by the SOM 235. Several different methods are common including: Linear, Cubic Spline (Catmull-Rom Spline), and Lanczos. These methods represent a trade-off between speed and accuracy, with Linear being the fastest and Lanczos being the most accurate.

In different embodiments, the resampling curve is determined with differing frequency by the SOM 235. A new resampling curve can be determined with each sweep of the laser 100 and the new resampling curve is used to linearize the interference data for that sweep and/or a subsequent or previous sweep of the laser by the SOM 235. In other examples, the resampling curve is resolved for every n-th sweep of the laser 100 and the linearization embodied in the resampling curve is used for the subsequent n sweeps. In still another example, non-linearities in the sweep of the laser 100 are determined and compared to a desired minimally acceptable linearization parameter. When the non-linearity of the sweeps has degraded to less than the minimally acceptable linearization parameter, a new resampling curve is calculated and then applied to subsequent sweeps and/or retroactively to previous sweeps of the laser. In still another example, the determined non-linearities are used to reprogram the laser controller 232 to more linearly sweep the laser 100.

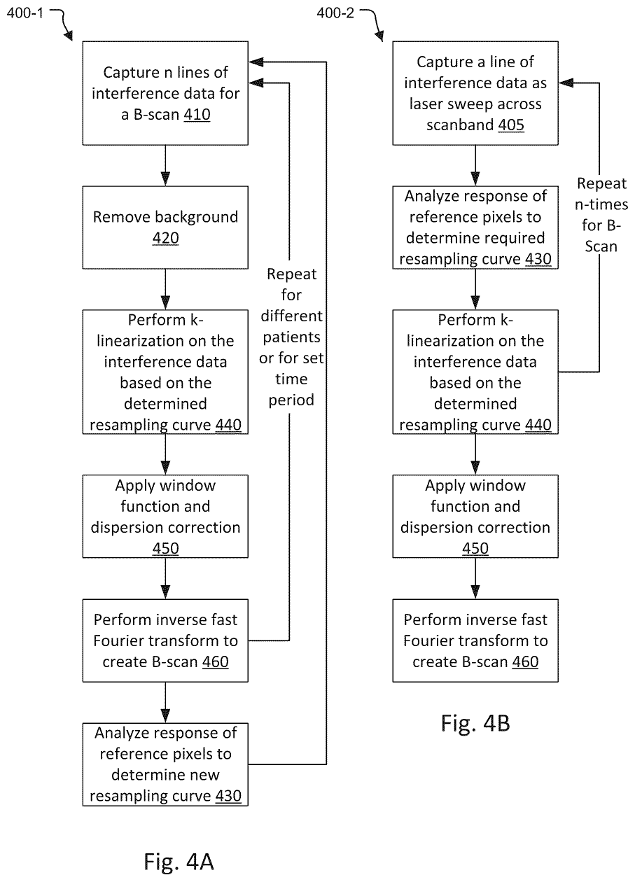

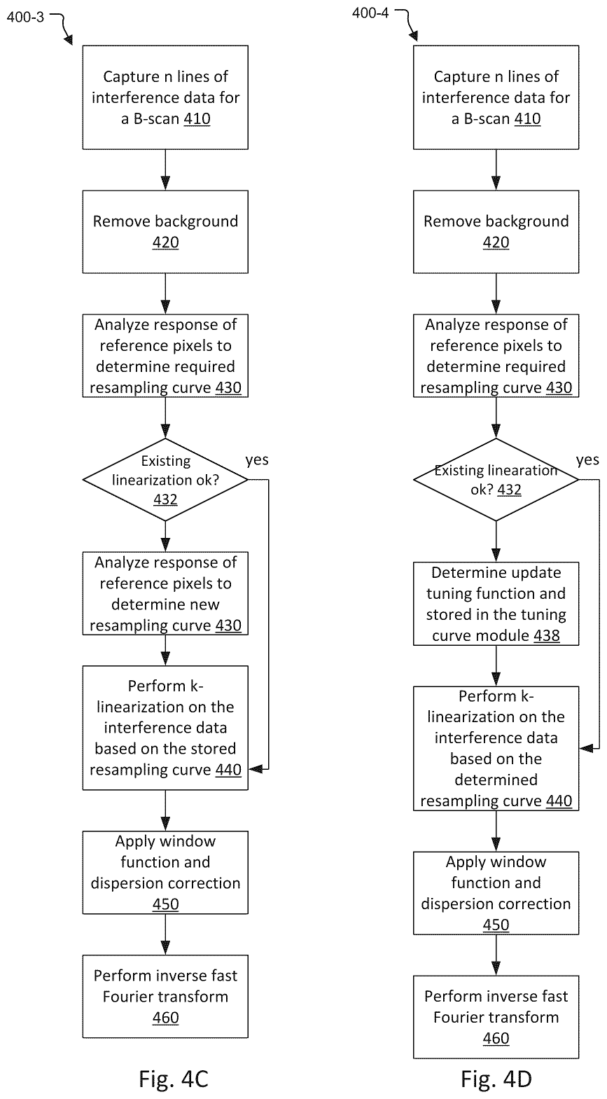

FIGS. 4A, 4B, 4C, and 4D are flow charts illustrating different approaches for calculating and applying a new resampling curve or more linear tuning for k-linearization in the OCT system 200. The resampling curve is used by the SOM 235 to correct non-linearities in the sweep of the laser 100 thereby ensuring accurate depth profiles in OCT imaging.

Briefly, FIG. 4A shows a process in which the resampling curve is periodically recalculated as part of a self calibration process, for example. In contrast, FIG. 4B shows a process in which the resampling curve is determined for every sweep of the laser. This continuous resampling curve calculation is useful when phase-stable OCT is required such as for OCT angiography applications. In a related process, a new resampling curve is calculated after a predetermined number of sweeps such as 100 or 1000 or more sweeps of the laser. FIG. 4C shows a process in which a new resampling curve is calculated when the laser's sweep linearity falls below a predetermined linearization threshold. Finally, FIG. 4D shows a process in which the laser's tuning function stored in the laser controller's tuning curve module 166 is additionally updated in response to determining that the laser's sweep linearity has fallen below a predetermined linearization threshold.

### Periodic Resampling Curve Recalculation

FIG. 4A depicts a process 400-1 where the resampling curve is periodically recalculated, for example, as part of a self-calibration process. The process begins at step 410, where n lines of interference data are captured as the laser 100 sweeps across its scanband. This interference data for the B-scan is collected by the line-field sensor 230.

In step 420, the background is preferably removed. In one example, a rolling average with a user-adjustable window size is utilized. Subsequently, the estimated background is subtracted from the spectrum. This step effectively eliminates the DC component in the resulting OCT images, proving particularly beneficial when employing an OCT swept source that produces sweeps with varying intensities.

In step 440, the resampling curve is used to perform k-linearization as described above.

In step 450, the window function is applied along with dispersion correction. In windowing, the raw data is multiplied by a window function, which sets the signal to zero outside of a predefined interval to reduce side lobes. Dispersion correction is another common correction in which wavenumber dependent phase shifts are corrected due to the presence of different lengths of dispersive media in the paths.

Finally in step 460, the B-scan is created from the sweeps by performing an inverse Fourier transform to yield the depth profiles across the B-scan.

These steps are repeated possibly for a set number of B-scans, a set number of patient scans or for a set time period.

After this has been repeated according to a programmed parameter of one or more scans or patients, or a programmed time period, in step 430, the SOM 235 analyzes the response of the reference pixels RP (such as RP1-RP6 in FIG. 3) to determine a new resampling curve. The periodic transmission pattern 316 from the frequency reference 310 is processed to identify non-linearities in the laser sweep and a newly calculated resampling curve is created by the SOM 235 to perform k-linearization on the next captured interference data, aligning the data points to a uniform k-space grid based on the new resampling curve for the next scans and/or next patients. The newly calculated resampling curve can also be applied retroactively to improve previous B-scans.

Thus, the process is repeated periodically as part of the system's self-calibration protocol.

### Continuous Resampling Curve Calculation

FIG. 4B illustrates a process 400-2 where the resampling curve is recalculated for every sweep of the laser 100. This continuous process is particularly suitable for phase-stable applications, such as OCT angiography.

In step 405, the sensor 230 captures a line of interference data as the laser 100 tunes across its scanband. In step 430, the response of the reference pixels RP is analyzed to determine the required resampling curve for that specific sweep.

In step 440, k-linearization is performed on the interference data using the determined resampling curve, ensuring accurate alignment in k-space.

These steps are repeated until interference data required for an entire B-scan has been collected across the laser's sweep of the scanband.

The process then proceeds with step 450, where a window function is applied and dispersion corrected, and step 460, where the IFFT is performed to generate the B-scan. This method ensures real-time calibration and imaging accuracy for each sweep.

### Threshold-Based Recalculation

FIG. 4C describes a method 400-3 where a new resampling curve is calculated only when the linearity of the laser sweep falls below a predetermined threshold. The process begins at step 410, capturing n lines of interference data for a B-scan.

The background is removed in step 420.

In step 430, the SOM 235 analyzes the response of the reference pixels RP to assess the laser's sweep linearity and the correctness of the current resampling curve. Step 432, the SOM 235 evaluates whether the existing current resampling curve is acceptable based on a predefined linearization threshold.

If the existing linearization is acceptable (Yes), the process skips to step 440, where k-linearization is performed using the existing/previous resampling curve. If the linearization is not acceptable (No), a new resampling curve is calculated in step 430 and instantiated as the current resampling curve. In step 440, the current resampling curve is applied to perform k-linearization.

Following k-linearization, a window function and dispersion correction are applied in step 450, and an IFFT is performed in step 460 to generate the B-scan. This threshold-based approach recalibrates the system only when necessary, balancing computational efficiency and imaging quality.

### Tuning Function Update

FIG. 4D extends the threshold-based recalibration process by including updates to the laser's tuning function stored in the tuning curve module 166. The process begins at step 410, capturing n lines of interference data during the laser sweep.

Background is removed in step 420.

In step 430, the SOM 235 analyzes the response of the reference pixels RP to determine the required resampling curve and thus the laser's tuning linearity. Step 432 evaluates whether the existing linearization is acceptable. If acceptable (Yes), the process proceeds with k-linearization in step 440.

If the linearization is not acceptable (No), the tuning function is updated in step 438. This involves recalculating the tuning parameters based on the laser's tuning transfer function and storing them in the tuning curve module 166 of the laser controller 232. This update ensures improved laser sweep linearity for future scans.

Once the resampling curve is applied, a window function is implemented in step 450, and an IFFT is performed in step 460 to create the B-scan. This method dynamically adapts the laser's tuning parameters to maintain system performance over time.

These processes, as illustrated in FIGS. 4A-4D, provide a versatile framework for managing k-linearization in the OCT system 200. The ability to calculate and apply resampling curves in real-time or as needed ensures high-quality depth profiles and tomographic images, accommodating diverse operational requirements and laser characteristics.

While this invention has been particularly shown and described with references to preferred embodiments thereof, it will be understood by those skilled in the art that various changes in form and details may be made therein without departing from the scope of the invention encompassed by the appended claims.

What is claimed is:

1. An optical coherence tomography system comprising:
a swept laser source configured to emit light with a wavelength that tunes across a scanband;
a line-field sensor comprising a linear array of pixels configured to detect interference signals corresponding to light scattered from a sample and reference light;
a frequency reference disposed to interact with a portion of the light emitted by the swept laser source and produce a reference pattern across the scanband, the periodic reference pattern being detected by pixels in the line-field sensor;
a computer configured to:
(a) determine a resampling curve based on the reference pattern to correct non-linearities in the tuning of the swept laser source;
(b) apply the resampling curve to k-linearize the interference signals detected by the line-field sensor; and
(c) perform an inverse Fourier transform on the k-linearized interference signals to generate depth profiles; and
a display configured to render tomographic images generated from the depth profiles.

2. The system of claim 1, wherein the frequency reference comprises an etalon configured to produce a periodic interference pattern as the swept laser source tunes across the scanband.

3. The system of claim 2, wherein the etalon is positioned so that it covers only a portion of the linear array of pixels, defining a set of reference pixels dedicated to detecting the periodic reference pattern.

4. The system of claim 3, wherein the reference pixels are located at one end of the linear array of pixels.

5. The system of claim 1, wherein the swept laser source comprises a cat's-eye configuration including a bandpass filter and an angle control actuator for tilt-tuning the filter to achieve the wavelength sweep.

6. The system of claim 1, wherein the computer is configured to recalculate the resampling curve periodically after a predetermined number of sweeps, thereby maintaining or improving the k-linearity over time.

7. The system of claim 1, wherein the computer is further configured to update a tuning function of the swept laser source.

8. The system of claim 1, further comprising a scanning mechanism configured to move the line of illumination across the sample, wherein the tomographic images are formed from a series of k-linearized depth profiles acquired at different lateral positions.

9. An optical coherence tomography system comprising:
a swept laser source comprising an intracavity mechanical tuning mechanism and a tuning curve module storing a predefined tuning function for controlling the tuning of the swept laser source;
a line-field sensor configured to detect interference signals and reference signals produced by a frequency reference during tuning of the swept laser source;
a controller configured to:
(a) evaluate linearity of the tuning based on the reference signals;
(b) determine a resampling curve to compensate for non-linearities in the wavelength tuning; and
(c) update the predefined tuning function in the tuning curve module; and
a processor configured to apply the resampling curve to k-linearize the interference signals and generate depth profiles for imaging.

10. The system of claim 9, wherein the frequency reference comprises an etalon positioned to cover only a portion of the line-field sensor's linear array of pixels, such that at least one pixel is designated for detecting a periodic reference pattern indicative of tuning linearity.

11. The system of claim 9, wherein the controller is configured to update the predefined tuning function after determining that the linearity of the tuning falls below a predefined threshold, ensuring improved wavelength sweep consistency in subsequent scans.

12. A method for optical coherence tomography imaging, comprising:
capturing, with a line-field sensor, interference signals corresponding to light scattered from a sample and reference light during tuning of a swept laser source;
detecting, with a subset of pixels in the line-field sensor, a periodic reference pattern generated by a frequency reference interacting with light from the swept laser source;
determining a resampling curve based on the periodic reference pattern to correct non-linearities in the tuning of the swept laser source;
applying the resampling curve to k-linearize the interference signals; and
performing an inverse Fourier transform on the k-linearized interference signals to generate depth profiles for tomographic imaging.

13. The method of claim 12, further comprising updating a predefined tuning function for the swept laser source based on the periodic reference pattern, thereby improving the linearity of subsequent wavelength sweeps.

14. The method of claim 12, wherein detecting the periodic reference pattern comprises using an etalon that covers only one or more selected pixels of the line-field sensor, enabling simultaneous acquisition of interference signals and reference signals with a single detector.

15. A method for calibrating a swept laser source in an optical coherence tomography system, comprising:
capturing reference signals produced by a frequency reference during wavelength tuning of the swept laser source;
analyzing the reference signals to evaluate the linearity of the wavelength tuning;
determining a resampling curve to compensate for non-linearities in the wavelength tuning and/or updating a tuning function stored in the swept laser source;
applying the resampling curve to k-linearize interference signals captured by the OCT system; and
generating tomographic images based on the k-linearized interference signals.
